(19) United States
(12) Patent Application Publication
(10) Pub. No.: US 2008/0231686 A1
(43) Pub. Date: Sep. 25, 2008

(54) GENERATION OF CONSTRUCTED MODEL FOR CLIENT RUNTIME PLAYER USING MOTION POINTS SENT OVER A NETWORK

(75) Inventor: Sanford Redlich, Sausalito, CA (US)

Correspondence Address: Trellis Intellectual Property Law Group, PC, 1900 EMBARCADERO ROAD, SUITE 109, PALO ALTO, CA, 94303, US

(73) Assignee: ATTUNE INTERACTIVE, INC. (a Delaware corporation), Sausalito, CA (US)

(21) Appl. No.: 12/054,347

(22) Filed: Mar. 24, 2008

Related U.S. Application Data
(60) Provisional application No. 60/896,494, filed on Mar. 22, 2007.

(51) Int. Cl. H04N 7/14

(52) U.S. Cl. 348/14.08

(57) ABSTRACT

Particular embodiments generally relate to generating video of a view of a constructed model which was generated using information derived by behavior tracking analysis of video. A webcam may capture video of a human user on a first device. A constructed model based on behavioral changes detected in the video for a first user is displayed on a second device. Motion points may be determined from the video. The motion points may be sent across a network to a second device for display. A client runtime application may be used to display a video view of a constructed model based on the motion points. Instead of having the client runtime application generate the constructed model and the video view of it, a local application running in the local operating system is used to generate the constructed model and video view. The local video generator takes the motion points and generates the constructed model. Audio data may be processed, transferred, and synchronized with the video data.

### CROSS REFERENCES TO RELATED APPLICATIONS

This application claims priority from U.S. Provisional Patent Application Ser. No. 60/896,494, entitled “TRAINING SYSTEM”, filed on Mar. 22, 2007, which is hereby incorporated by reference as if set forth in full in this application for all purposes.

### BACKGROUND

Particular embodiments generally relate to video generation.

In a synchronous communication over a network, video may be sent from a first video-capable client runtime player such as the Adobe Flash Player to a second Adobe Flash Player. The first client runtime player compresses the video and sends it across a network to the second client runtime player. The second client runtime player then decompresses the video and can display it. Even though video is compressed before being sent across the network, a large amount of bandwidth is used. Also, users may prefer to preserve dignity or anonymity by being represented as an avatar of any type, from a photorealistic representation of the user's actual appearance to an arbitrary representation such as a cartoon. This, however, uses even more processing power than sending the compressed video.

### SUMMARY

Particular embodiments generally relate to generating video of a view of a constructed model which was generated using information derived by behavior tracking analysis of video. A webcam may capture video of a human user on a first device. A constructed model based on behavioral changes detected in the video for a first user is displayed on a second device, which may be participating in a synchronous or asynchronous communication with the first device. In one embodiment, motion points may be determined from the video. These motion points track changes in features of the user in the video. The motion points may be sent across a network to a second device for display.

A client runtime application, such as the Adobe Flash Player, may be used to display a video view of a constructed model based on the motion points. The client runtime application may have specific requirements on how data is to be input into the application. For example, video information may only efficiently be received from a webcam, or information may only be allowed to pass from the operating system into the client runtime application via a restricted security file or folder. Accordingly, the motion points may be passed from client runtime to an application running on the local operating system by storing the motion points in a designated trusted file or folder. The client runtime and the local operating system application may each detect that the motion points have been stored or changed in the designated trusted file or folder and retrieve them.

For efficiency and performance, instead of having the client runtime application generate the constructed model and the video view of it, a local application running in the local operating system is used to generate the constructed model and video view. The local video generator takes the motion points and generates the constructed model. For example, an avatar model is generated that reflects the expression that was detected from the video of the first user. Then the local video generator generates a video view of that avatar model. Because the client runtime application has improved performance when video is received from a webcam driver, a simulated webcam is also generated through which the video view of the constructed model can be passed to the client runtime application. The client runtime application thinks it is receiving video from a webcam, but it is receiving video from the local video generator that is generating a video view of the constructed model. When the runtime application receives the video, it can display the video.

Additionally, a video view of a second constructed model of a second user using the second device may also be displayed along with the constructed model of the first user. Video may be received from a webcam associated with the second device. Motion points may be determined as described above. Also, the motion points may be used to generate a video view of the constructed model as described above.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system according to one embodiment.

FIG. 2 shows the process of generating video according to one embodiment.

FIG. 3 depicts a more detailed example of the device according to one embodiment.

FIG. 4 depicts an example of an interface 400 for a display according to one embodiment.

FIG. 5 depicts a more detailed example of a device according to one embodiment.

FIG. 6 depicts an example showing audio being transferred according to one embodiment.

FIG. 7 depicts an example of a training system for providing a training program according to one embodiment.

### DETAILED DESCRIPTION OF EMBODIMENTS

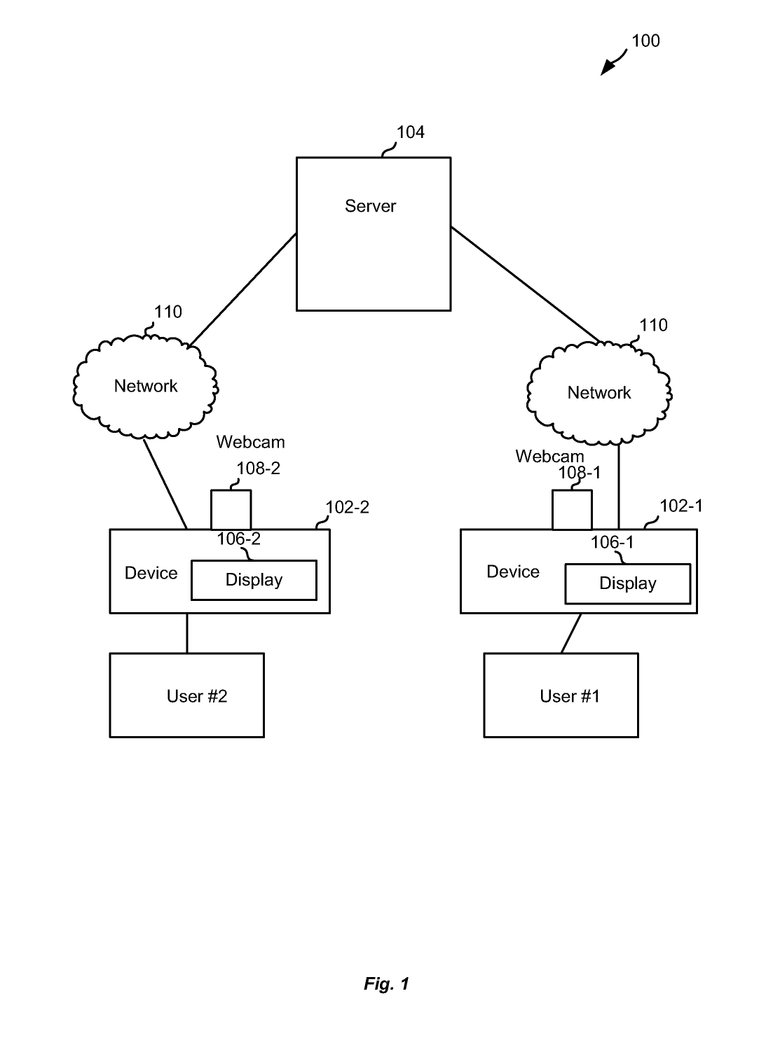

FIG. 1 depicts an example of a system 100 according to one embodiment. System 100 allows synchronous or asynchronous communication between device 102-1 and device 102-2. As shown, devices 102, displays 106, and webcams 108 may be provided. Also, a server 104 may be used to communicate between devices 102 through networks 110. Although these components are shown, it will be understood that variations of system 100 may be provided.

Device 102 may include a computing device, such as a personal computer, cellular phone, Smart phone, or any other device that can process video.

Display 106 may be provided and may be part of device 102, external to device 102 or integrated with device 102. Display 106 may be a liquid crystal display (LCD), a monitor, an integrated display in device 102, etc. Display 106 is configured to display video.

Webcam 108 may include a capture device that captures the video of a user. Webcam 108 may capture the video and provide the video to device 102. Webcam 108 may include cameras, motion detectors, and other video capture devices. Webcam 108 is associated with capturing video for a runtime application.

Network 110 may include a network configured to send data, such as a wide area network (WAN). Network 110 may also include the Internet, a local area network (LAN), intranet, extranet, etc.

Server 104 may include a network device that provides routing of data between device 102-1 and device 102-2. In one embodiment, server 104 may be a shared server in which device 102-1 and device 102-2 may access data that is stored on it.

A synchronous or asynchronous system is provided in which information is communicated between device 102-1 and device 102-2. Synchronous communication may include real-time video, audio, simulated video, teleconferencing, Internet-based teleconferencing, instant message chatting. The simulated video is where one or more users are represented by a constructed model, such as an avatar or other visual representation of the user. The asynchronous communication may be a system in which communication may not occur in at the same time. For example, the motion points for the video may be stored played at a later time.

The synchronous or asynchronous communication may be used in a training program. A training program is provided that uses a challenge and response format. The training program may be instructing a trainee in any subject matter. For example, the training may be for a job, for a class at school, for learning safety procedures, etc. A trainer and trainee may participate in the training program. For example, the challenge may represent a customer question and the answer may represent what a salesperson would say. This spoken practice in responding to questions, and subsequent review of the simulated conversation by the user, trainer and or peers, allows rapid development of interpersonal communication skills. Further, the question and answer format provides a new, more human approach to learning and testing by putting the test in the most natural possible form: a person's question. Perfecting the answer simultaneously tests and trains knowledge, the ability to communicate that knowledge, and the ability to establish emotional rapport with the questioner. An example of a training system is described in more detail below.

In one embodiment, video from webcam 108-2 is taken of a user. Behavioral analysis for the user may be performed to determine if the user has changed his/her behavior. For example, behavior tracking may monitor motion points for features that change for a user. This may monitor changes in expression for a user. The motion points may be information that tracks a user's features, such as a user's facial features. For example, a number of points, such as 28, may be monitored on video for a user. When features of a user change position, the location of the features may be determined and represented as 3-D motion points. The motion points may represent positional information for the features in a spatial domain. For example, each motion point may include positional information for a feature in a coordinate space including but not limited to: X-Y-Z space, X-Y in a face-plane on a head model which tilts, rotates and yaws, or others.

The motion points may be sent through network 110 instead of sending the video or compressed video. This preserves bandwidth as the data set describing the motion points is smaller in size than an equivalent frame of video or compressed video.

The motion points may be used by device 102-1 to generate a constructed model for the user. For example, an avatar may be animated based on the motion points. The avatar is animated by associating the position of the motion points with corresponding features of the avatar. As the position of the features changes, the expression of the avatar changes. This provides video of the avatar that tracks the changes in the expression of the user. As mentioned above, the communication may be synchronous or asynchronous and the reverse process may be performed. For example, a user #1 for device 102-1 may be viewing a constructed model of user #2 and user #2 is viewing a constructed model for user #1. Additionally, one user may see video while the other sees an avatar animated based on the motion points.

As will be discussed below, a client runtime application, such as the Adobe Flash Player, the Microsoft Silverlight player, etc., may be used. Such a client runtime allows information from the Internet to generate a consistent user experience across major operating systems, browsers, mobile phones, and devices while limiting security concerns by restricting access to the underlying operating system. It is an application running on a local operating system which effectively creates a second operating system that is specialized for interacting with the Internet and generating user experiences. The client runtime player may include restrictions on how data can be sent to it and sent from it to the local operating system. Accordingly, particular embodiments send the motion points using a restricted folder that can be accessed by the runtime application. For example, a designated trusted folder with a limited storage size may be used. Also, the motion points may be used to generate video of the constructed model. A simulated webcam may be used to pass the video of the constructed model to the runtime application. Accordingly, the client runtime application thinks it is receiving video from a webcam but in reality it is receiving video for the constructed model that is generated using the motion points.

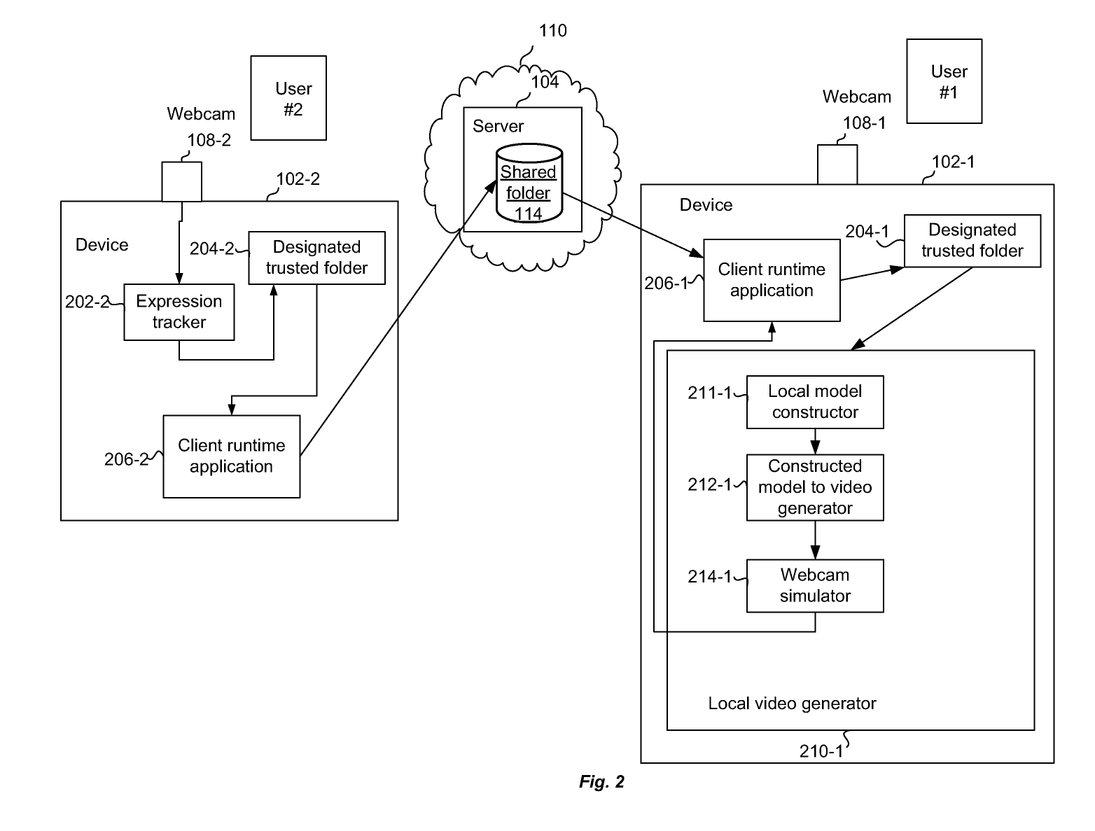

FIG. 2 shows the process of generating video according to one embodiment. The process is shown in one direction in this case; however, as will be described below, the process can be performed in both directions in a synchronous communication. Webcam 108-2 takes video of user #2. The video may be of any part of user #2's body, or the whole of user #2's body. For example, a facial portion of user #2 may be taken as video.

The video is passed to an expression tracker 202-2. The expression of user #2 is then analyzed. For example, a number of motion points may be measured for user #2. Features on a face in the video may be determined and associated with motion points. When the features move, changes in the location of the motion points may be determined. Although expression tracking is described, it will be understood that other movements may be tracked, such as gestures. Expressions and gestures that may be detected may include a user smiling, frowning, moving eyes or eyebrows, moving any facial feature or body part, etc.

The motion points may indicate motion that has occurred when referenced to a prior frame of video. For example, in a prior frame of video the user may be frowning, but in the current frame of video the user may be changing his/her expression to be smiling. The motion points may indicate the changes in location of features when the user changes his/her expression.

The motion points may be passed through a designated trusted folder 204-2. The designated trusted folder may be a restricted folder for a client runtime application 206-2. As mentioned above, client runtime application 206 may have certain restrictions on how data can be passed to and from it. For example, in the Adobe Flash Player it is difficult to send data from the local operating system unless it is passed to it through a designated trusted folder. Similarly, to overcome security restrictions on playing both local and Internet video, it may be advantageous to transmit the video through a webcam driver or a simulated webcam driver. Designated trusted folder 204-2 is used for passing security information, such as information for the local client, such as device 102-2. This may be configuration information for client runtime application 206-2. Designated trusted folder 204-2 may have a storage restriction that is less than the size of sending frames of the video, for example if it is a default trusted folder limited to some maximum size such as 100K bytes. For example, the video view of a constructed model or the video of the user may be larger than that which can be stored in designated trusted folder 204-2.

Client runtime application 206-2 is configured to monitor designated trusted folder 204-2 for any changes. For example, designated trusted folder 204-2 may be polled for changes. When a change is detected, the changes may be sent over network 110 to server 104. A shared folder 114 may be used to share information between client runtime application 206-2 and client runtime application 206-1. The motion points may be sent through shared folder 114 to client runtime application 206-1.

When client runtime application 206-1 receives the motion points, it stores them in designated trusted folder 204-1. A local video generator 210 may then use the motion points to generate a constructed model and provide it as video to client runtime application 206-1.

A model constructor 211-1 receives the motion points and is configured to construct a frame of a model. For example, a frame that includes an avatar based on the motion points may be constructed. The motion points determine where in the avatar corresponding features should be configured and the avatar is generated with an expression that corresponds with the expression of the user.

A constructed model to video generator 212-1 is then configured to generate a video frame of a view of the constructed model. For example, a video frame of a view of an avatar is generated. The constructed model is a representation which may be in two or three dimensions, as vector information, or any other representation. The video frame is a two dimensional view of the constructed model which conforms to standards required for video display.

A webcam simulator 214-1 is configured to simulate a webcam which allows access to the video frame. For example, a representation of a webcam is generated such that client runtime application 206-1 thinks it is receiving information from a webcam. However, in this case, the webcam is abstract and the video has actually been generated using the motion points. Webcam simulator 214-1 may appear to be a normal webcam available to applications running in the local operating system. This simulated webcam may be used to send the video frame to client runtime application 206-1. As described above, a webcam may be the only efficient means available to transmit video into the client runtime application 206-1, depending on the client runtime's security restrictions. Accordingly, a webcam is simulated in order to provide the video frame to client runtime application 206-1.

Client runtime application 206-1 is then configured to output the video frame on display 106-1. A series of video frames may be received by client runtime application 206-1 and displayed to provide an animation of the constructed model. The series may show a change in expression of the constructed model based on the motion points determined from the video of the user. The above process sends motion points across network 110 instead of the full video or compressed video. This saves bandwidth and provides a way for client runtime application 206-1 to receive and send the motion points using designated trusted folder 204-1.

The processing required to generate the constructed model is highly intensive and thus may need to be performed on the local machine, such as device 102-1. If the processing is performed on server 104, performance may not be optimal. For example, latency may be experienced, bandwidth may be unnecessarily used, and extra cost may be incurred. If the constructed model is created on the server, the video view of the constructed model needs to be sent to a user's device. To make the constructed model appear realistic, the transfer should occur at 25 frames/sec with a total delay of <50 ms from user action to seeing the displayed result as an avatar. Bandwidth limitations do not allow this exchange. Also, bandwidth is also important because the benefit of this system is limiting bandwidth and doing server-side processing would remove that benefit. Lastly, the user's device is often underutilized so the processing is effectively unused. If the processing is performed on the server, then processing is often paid for unnecessarily. Also, client runtime application 206 generally cannot perform this type of computation because for efficient operation it requires access to a graphics processor of device 102, which client runtime application 206 may not have. Rather, client runtime application 206 uses processing cycles of the machine's central processing unit. The graphics processor provides highly parallel processing specialized for graphics processing that is needed to generate the constructed model in a timely manner.

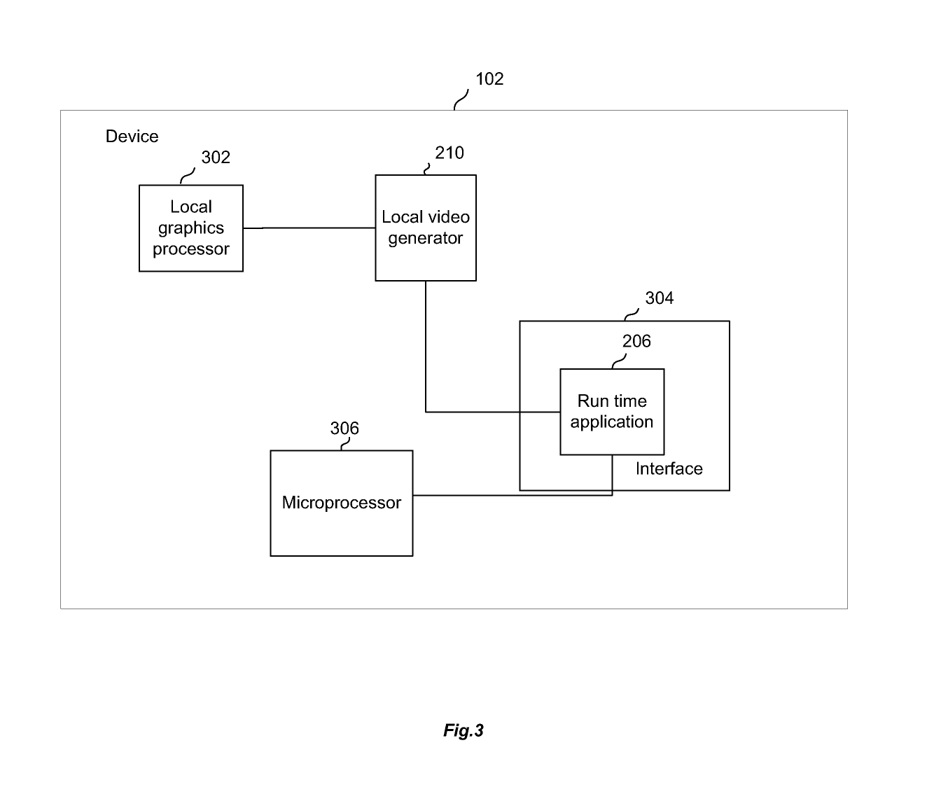

FIG. 3 depicts a more detailed example of device 102 according to one embodiment. As shown, local video generator 210 is connected to a local graphics processor unit 302. The cycles of local graphics processor unit 302 are used to generate the constructed model using the motion points. In one embodiment, local video generator 208 may be downloaded to device 102 and configured to interact with local graphics processor unit 302. This may be different from client runtime application 206, which may be running in interface 304, such as an Internet browser or may be running in its own application for the client runtime, for example the Adobe Integrated Runtime. Internet browser and client runtime application 206 may be run in an operating system that is controlled by a microprocessor 306. Microprocessor 306 may be configured to run an operating system for device 102. This is different from local graphics processing unit 302, which processes graphics for local device 102. Accordingly, local graphics processing unit 302 is specialized for highly parallelized graphics processing and can thereby efficiently be used to generate the video from the motion points.

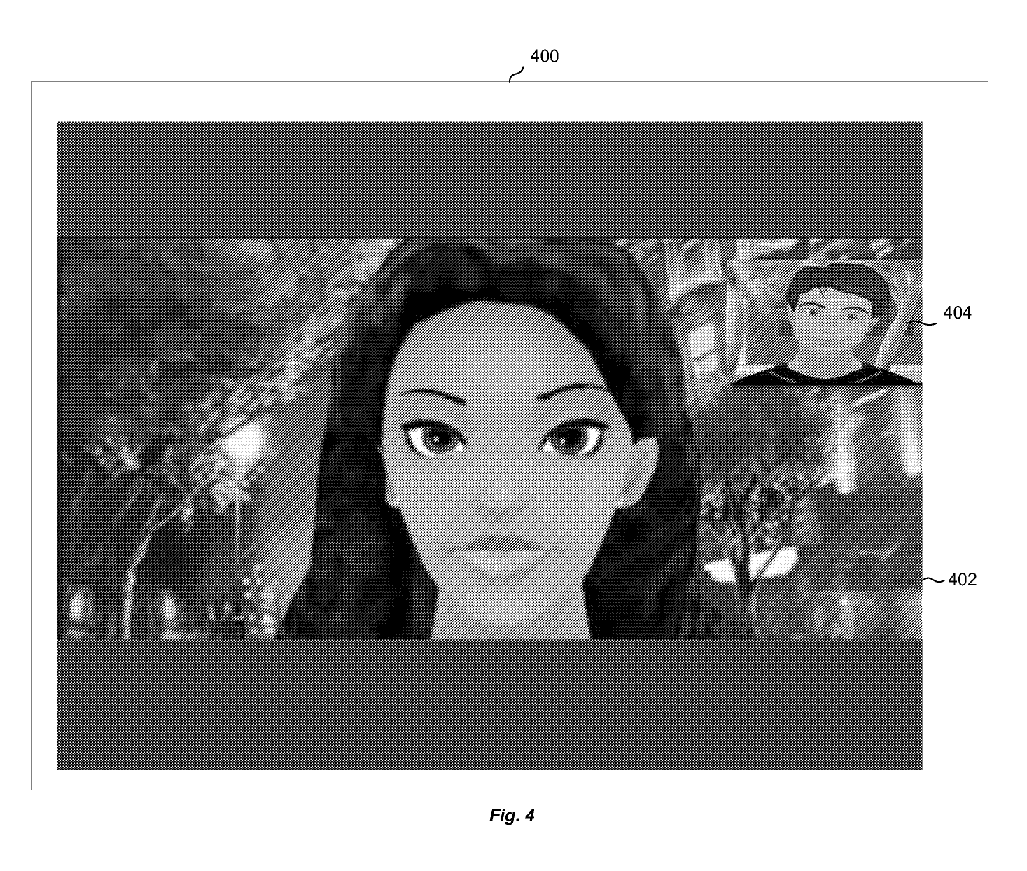

FIG. 4 depicts an example of an interface 400 on display 106 according to one embodiment. A first window 402 may include video for a user #2. Also, video for user #1 may be shown in a window 404. Although this arrangement is shown, it will be understood that other arrangements will be appreciated. For example, a video of user #1 may not be shown.

The video of user #2 may be a video frame of a view of the constructed model that is generated. Client runtime application 206 may generate and output the constructed model to interface 400 for display in window 402. As the expression of user #2 changes, the movement of the constructed model is changed. Thus, the movements of user #2 are matched by the constructed model.

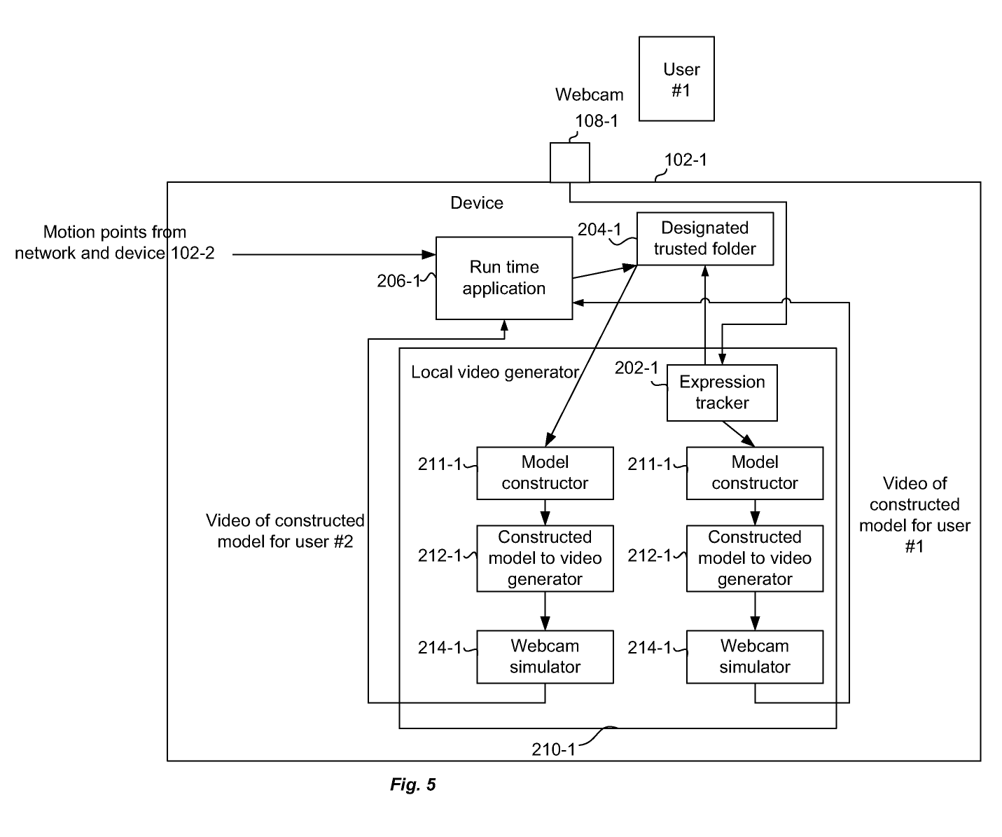

FIG. 5 depicts a more detailed example of devices 102-1 and 102-2 according to one embodiment. As shown, in both synchronous and asynchronous uses, video frames for both user #1 and user #2 are provided to client runtime applications 206. For example, video of user #1 may be taken by webcam 108-1. The video is sent to expression tracker 202-1, which determines the motion points as described above. The motion points are sent to model constructor 211-1. A constructed model is generated and sent to constructed model-to-video generator 212-1. Constructed model to video generator 212-1 generates a video frame and sends it to webcam simulator 214-1. The webcam is simulated and the video frame is sent to client runtime application 206-1.

Also, the process described above with respect to generating a video frame for the constructed model for user #2 is provided. Motion points are received for device 102-2, stored in designated trusted folder 204-1, and sent to model constructor 211-1. Accordingly, a single device can generate a constructed model for a user #1 and also generate a constructed model for a user #2.

The determination of the motion points may depend on the video that is taken of the user. The motion points may be unreliable at certain points, such as they may depend on lighting conditions, visual occlusions, etc. Thus, certain supplementing of the motion of the constructed model may be performed. For example, local video generator 210 may supplement the motion points with historical models of the user's behavior. Thus, the constructed model may be animated based on the user's prior behavior. For example, if the user is likely to smile, a smile may be generated for the constructed model. Also, generic user behavior previously derived from other users may be used such that the movements may still appear natural. The constructed model may be generated based on behavior information, which may include the behavior of the second user in the video recording, the behavior of the second user in past recordings, the behavior of the first user, the behavior of the first user in the past, and previously stored typical human expressive behaviors. For example, if an angry challenge is desired, the second user would act in an angry manner in the recording. This angry behavior may then be detected and used to generate the constructed model with an angry demeanor.

During the response, recordings of the first or second user's past behaviors may be analyzed to provide behavior characteristics of desired emotions such as anger or curiosity and these characteristics may be generated in the constructed model. Real-time user behavior may be similarly analyzed and used to determine appropriate reactions on the part of the constructed model. Examples of data used for behavioral analysis include audio frequency and amplitude, gesture tracking, user feature tracking, emotional state tracking, eye contact tracking, or other data which can be used to determine a user's behavior. Thus, the constructed behaves appropriately to create an emotional face-to-face interaction with the users.

Additionally, other methods of determining the motion points may be used in addition to analyzing the video from webcam 108. For example, an infrared camera and/or an infrared illumination source may be used. This may allow use in low light conditions.

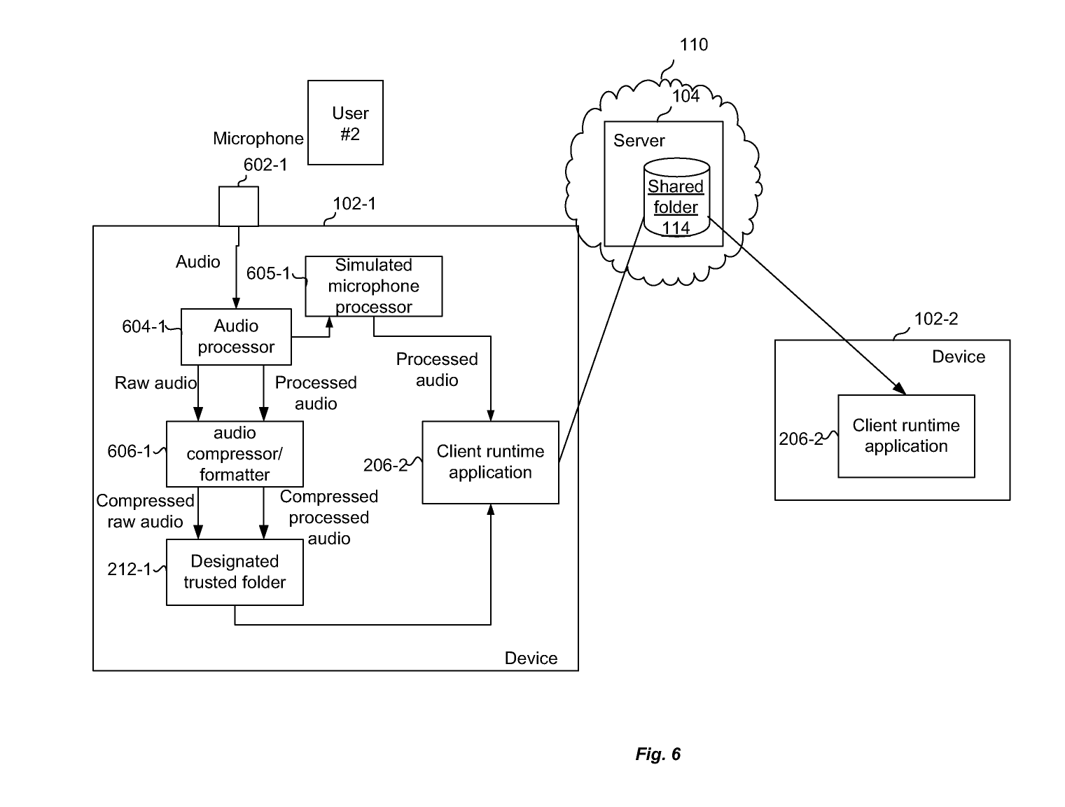

Also, although video is described, audio may also be sent to be played along with the video. FIG. 6 depicts an example showing audio being transferred according to one embodiment. Audio information may be received from a microphone 602-1. A raw audio signal is received at an audio processor 604-1. In some instances, the raw audio signal may be processed. For example, for a constructed model, the audio may be changed, such as a person's voice may be disguised or changed in pitch, timbre, etc.

The audio may be passed to device 102-2 in different ways. For example, the audio may be passed as a simulated microphone for device 102-1 to client runtime application 206-1. The simulated microphone may be passed in as if it is the microphone for webcam 108-1. The process of simulating the microphone may be performed such that it can be input into client runtime application 206-2 with or without processing to change pitch, timbre, etc. A simulated microphone 605-1 presents the audio data to the client runtime application 206-1 as if it was a standard microphone available to applications on the local operating system because client runtime application 206-1 may have restrictions on how audio is sent to it and/or because the client runtime application may handle the audio differently when received from a microphone. For example, the client runtime may have built-in systems to compress audio received from the microphone and send it to a server through standard means. By doing the processing on device 102-1, the audio may be sent through the network more efficiently. When audio is intercepted from microphone 602-1 and processed, it can no longer be input into client runtime application 206-1 as being from a microphone. Thus, the microphone simulation is performed.

Also, the raw audio signal may be compressed by an audio compressor/formatter 606-1. For example, an MP3 of or other compressed form of audio may be generated from raw audio and/or from audio processed to change qualities such as pitch, timbre, equalization, etc. The compressed audio may be stored in designated trusted folder 204-1. As discussed above, client runtime application 206-1 monitors the folder and may retrieve the compressed audio from it.

The audio may be sent to device 102-2 with the motion points. For example, the processed audio received as a simulated microphone is sent with the motion points to shared folder 114 on server 104. Also, the compressed audio or processed audio may be sent to shared folder 114 on server 104 with the motion points. Also, the audio encoding may allow the motion points data to be encoded directly into the audio data. For example, the motion points can be superimposed as metadata on the audio data. Also, video of the user may be sent with the audio instead of, or in addition to, the motion points.

For client runtime application 206-2 to play the audio, a request is sent to server 104 for the audio. The audio data is sent to client runtime application 206-2. Also, the motion points are sent to designated trusted folder 204-2 as described above. When client runtime application 206-2 detects the audio is ready to begin playing and the motion points are available, the audio is triggered to play and also triggers local video generator 210-2 to begin generating video. A flag may be set in designated trusted folder 204-2 that causes video generation. If the motion points were sent as metadata, client runtime application 206-2 may store the motion points and video generator 210-2 uses them to generate the video.

The audio and/or video may also be stored for later playback. Client runtime application 206-2 may determine that audio should be played back. Client runtime application 206-2 then triggers playback of the audio. Also, local video generator 210-2 is triggered to begin generating video.

The audio may be paused during playback. Client runtime application 206-2 may receive an indication to pause the audio/video. The playback of the audio is paused and also the video generation is paused. For example, a flag to pause the video generation may be set to cause the pausing. When an indication to resume playing the audio is received, client runtime application 206-2 resumes playback of the audio and sets a flag to continue video generation.

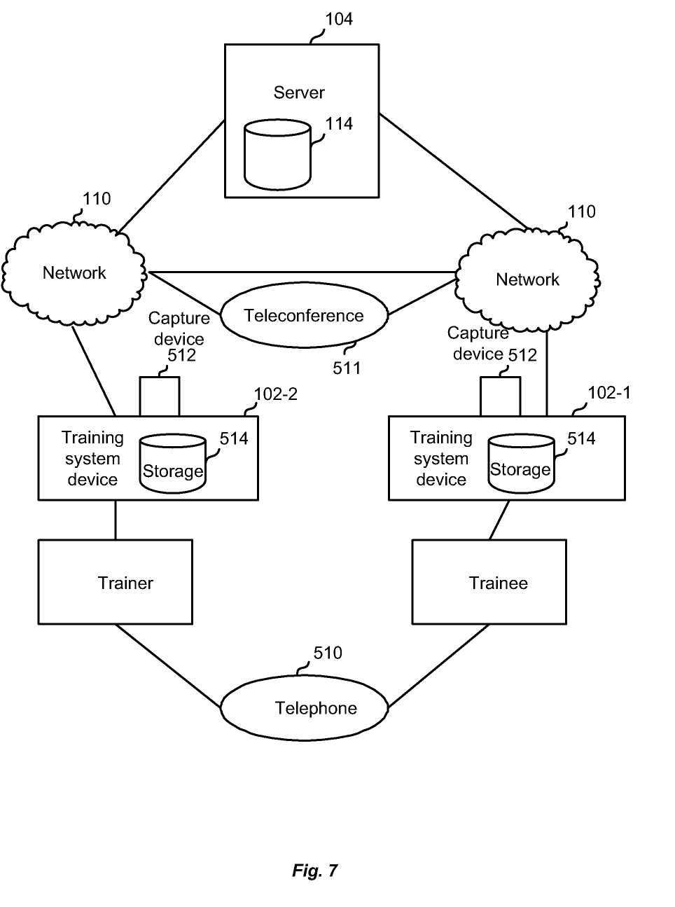

As mentioned above, the synchronous or asynchronous communication may be used in a training program. FIG. 7 depicts an example of a training system for providing a training program according to one embodiment. A training program is provided that uses a challenge and response format. The training program may be instructing a trainee in any subject matter. For example, the training may be for a job, for a class at school, for learning safety procedures, for workplace compliance training, etc.

A first training system device 102-1 may be used by trainee to participate in a training program. A second training system device 102-2 may also be operated by a trainer. Other training system devices may also be used, but are not shown. Training system devices 102 may include a computing device that can communicate through networks 110 and examples include a desktop personal computer, a laptop personal computer, Smart phones, cellular phones, work stations, set top boxes including televisions, or other suitable networked devices. Devices 102 may communicate through a network 110, which may include a server 104. Networks 110 may include wireless and/or wired networks, such as the Internet, a local area network (LAN), a wide area network (WAN), and a cellular network.

A trainer and trainee use the training system. The trainer and trainee may be described as taking particular actions. In some cases, the roles may be reversed. Thus, when trainer and trainee are described, it should be understood that when the trainee and/or trainer are being referred to, they may be the same user, a different user, or multiple combinations of users. The trainer and trainee may use network communication such as teleconference 511 or a telephone 510 to participate in a teleconference. This allows real-time interaction between the trainee and trainer allowing the trainee to speak with a trainer during the training session.

Training system devices 102 may include capture devices 512 that can record aspects of a trainee's or trainer's behavior. For example, video, audio, motion, infrared radiation, active infrared radiation, heart rate, blood pressure, hand squeeze pressure, electroencephalogram and/or galvanic skin resistance, or other recorded information may be captured. Examples of capture devices 512 include cameras, video recorders, infrared recorders, infrared cameras, visible light cameras, etc. Other components of training system devices 102 may also be included and will be described in more detail below.

The trainee can interact with device 102-1 to participate in a training program. Content for the training program may be stored in storage 514. Storage 514 may be included in various locations and may be distributed. For example, storage 514 may be found in device 102-1, server 104, and/or device 102-2. The content may be transmitted through networks 110 if it is stored on server 104 or device 102-2. The data itself may be in any format including extensible markup language (XML), Adobe flash video, MP3 audio, MPEG video, or other storage formats.

Additional details of a training system are provided in U.S. application Ser. No. 11/946,784, entitled “Training System using Interactive Prompt Character”, filed Nov. 28, 2007, which is incorporated by reference in its entirety for all purposes.

Although the description has been described with respect to particular embodiments thereof, these particular embodiments are merely illustrative, and not restrictive. Although training systems are discussed, it will be understood that particular embodiments may be used for purposes other than training, such as for classroom study, test taking, etc.

Any suitable programming language can be used to implement the routines of particular embodiments including C, C++, C#, Java, Flex, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for generating video, the method comprising:
receiving, over a network at a first device, motion points for video of a second user taken by a web camera from a second device, the motion points determined by a behavioral analysis in a video capture of the user using the web camera;
generating, using a local graphics processor of the first device, a constructed model for the user using the motion points;
generating a frame of video for the constructed model; and
inputting the frame of video into a client runtime application by simulating that the video frame was received from a web camera of the first device.

2. The method of claim 1, wherein receiving motion points comprises receiving the motion points from a shared folder on a server, wherein video of the user is not sent over the network.

3. The method of claim 1, wherein inputting the frame of video into the client runtime application comprises:
creating a representation of a web camera of the first device; and
sending the frame of video using the web camera representation to the client runtime application with an indication the frame is from the web camera of the first device.

4. The method of claim 1, wherein the motion points are stored in a designated trusted folder for the client runtime application, the designated trusted folder being a method to pass data to the client runtime application.

5. The method of claim 4, wherein the designated trusted folder is limited in size to an amount of storage less than the video frame for the user.

6. The method of claim 1, further comprising:
receiving, at the first device, motion points for video of a first user taken by a web camera from the first device, the motion points determined by a behavioral analysis in a video capture of a user using a webcam;
determining a constructed model associated with the first user using the motion points using a local graphics processor for the first device;
determining a frame of video for the constructed model; and
inputting the frame of video into the client runtime application by simulating that the video frame was received from a web camera of the first device.

7. The method of claim 1, further comprising:
receiving, at the first device, video of a first user taken by a web camera for the first device;
determining motion points for the video of the first user, the motion points determined by a behavioral analysis; and
storing the motion points in a designated trusted folder for the client runtime application, wherein the storing the motion points causes the client runtime application to retrieve the motion points.

8. The method of claim 7, wherein the client runtime application sends the motion points to the second device, wherein the second device is configured to generate video of a second constructed model using the motion points.

9. The method of claim 1, further comprising:
receiving audio from a microphone associated with the first device;
processing the audio from the microphone;
simulating the processed audio is received from the microphone for the first device;
inputting the audio into the client runtime application; and
sending the audio to the second device for output.

10. The method of claim 9, further comprising:
adding the motion points to the audio data before sending the audio to the second device for output.

11. The method of claim 1, further comprising:
receiving, at the first device, audio from the second device;
determining when the audio is ready to be played;
wherein generating the video frame is triggered such that the video frame is outputted in a synchronized manner with audio being played.

12. An apparatus configured to generate video, the apparatus comprising:
a local graphics processor;
a client runtime application; and
a video generator configured to:
receive, over a network, motion points for video of a user taken by a web camera from a device, the motion points determined by a behavioral analysis in a video capture of the user using the web camera;
generate, using the local graphics processor, a constructed model for the user using the motion points;
generate a frame of video for the constructed model; and
input the frame of video into the client runtime application by simulating that the video frame was received from a web camera of the apparatus.

13. The apparatus of claim 12, further comprising a designated trusted folder for the client runtime application, wherein the motion points are stored in the designated trusted folder such that the client runtime application can retrieve them.

14. Software encoded in one or more tangible media for execution by the one or more processors and when executed operable to:
receive, over a network at a first device, motion points for video of a user taken by a web camera from a second device, the motion points determined by a behavioral analysis in a video capture of the user using the web camera;
generate, using a local graphics processor of the first device, a constructed model for the user using the motion points;
generate a frame of video for the constructed model; and
input the frame of video into a client runtime application by simulating that the video frame was received from a web camera of the first device.

15. The software of claim 14, wherein the software operable to receive motion points comprises software operable to receive the motion points from a shared folder on a server, wherein video of the user is not sent over the network.

16. The software of claim 14, wherein the software operable to input the frame of video into the client runtime application comprises software operable to:
create a representation of the web camera of the second device; and
send the frame of video using a driver for the web camera to the client runtime application with an indication the frame is from the web camera of the first device.

17. The software of claim 14, wherein the motion points are stored in a designated trusted folder for the client runtime application, the designated trusted folder being a method to pass data to the client runtime application.

18. The software of claim 14, wherein the software is further operable to:
receive, at the first device, motion points for video of a second user taken by a web camera from the first device, the motion points determined by a behavioral analysis in a video capture of a user using a webcam;
determine a constructed model associated with the second user using the motion points using a local graphics processor for the first device;
determine a frame of video for the constructed model; and
input the frame of video into the client runtime application by simulating that the video frame was received from a web camera of the first device.

19. The software of claim 14, wherein the software is further operable to:
receive, at the first device, video of a second user taken by a web camera for the first device;
determine motion points for the video of the second user, the motion points determined by a behavioral analysis; and
store the motion points in a designated trusted folder for the client runtime application, wherein the storing the motion points causes the client runtime application to retrieve the motion points.

20. The software of claim 14, wherein the software is further operable to:
receive audio from a microphone associated with the first device;
process the audio from the microphone;
simulate the processed audio is received from the microphone for the first device;
input the audio into the client runtime application; and
send the audio to the second device for output.
